(19) United States
(12) Patent Application Publication
(10) Pub. No.: US 2026/0227274 A1
(43) Pub. Date: Aug. 6, 2026

(54) Integrated Differential Testing System

(71) Applicant: Jason Desrosiers, Bellingham, MA (US)

(72) Inventor: Jason Desrosiers, Bellingham, MA (US)

(21) Appl. No.: 19/042,074

(22) Filed: Jan. 31, 2025

(51) Int. Cl. G01M 3/32

(52) U.S. Cl. CPC G01M 3/3272; G01M 3/3209

(57) ABSTRACT

A method for evaluating seal integrity in a dynamic pressure vessel is provided. The method involves applying a vacuum, holding the vacuum, and moving a dynamic portion of the pressure vessel while holding the vacuum. Then, a high pressure is applied to the pressure vessel, held, and then the dynamic portion is again moved while holding the high pressure. Data is recorded and tracked over time. The method, and related systems allowing the carrying out of the method, is useful for advanced monitoring of seal integrity in dynamic systems.

### BACKGROUND OF THE INVENTION

The present disclosure relates generally to testing systems and methods to evaluate seal integrity. More particularly, the present disclosure relates to testing systems and methods to evaluate seal integrity in dynamic pressure vessels such as pipettes, pistons in motors, hydraulic pistons and hydraulic systems, and the like.

Seal integrity in dynamic pressure vessels is important in use cases such as laboratory settings, industrial settings such as machinery and piston applications of various kinds, as well as consumer settings such as piston seal integrity in internal combustion engines.

Prior art seal integrity testing involves only single or limited condition testing methods such as dye tests or gravimetric tests which do not address a full range of operation nor are changes measured over time or under dynamic conditions. Indeed, many seal failures are only observable under such conditions, which are missed using prior art testing methods and systems.

Therefore, what is needed is a seal testing method and system to evaluate seals of dynamic pressure vessels.

### SUMMARY OF THE INVENTION

The subject matter of this application may involve, in some cases, interrelated products, alternative solutions to a particular problem, and/or a plurality of different uses of a single system or article.

In one aspect, a method of evaluating seal integrity is provided. The method involves attaching a dynamic pressure vessel having a seal to a testing apparatus via a manifold. The dynamic pressure vessel may be any vessel having structure to adjust internal volume and/or pressure, such as a pipette, syringe, combustion engine piston chamber, and the like. A vacuum may then be drawn within the dynamic pressure vessel, against the seal, using a vacuum source connected to the manifold. The vacuum (or equivalent low pressure), is then held for a predetermined time period via an isolation valve positioned along the vacuum path. During this time period, pressure within the dynamic pressure vessel is measured to seek to identify any leaks in the seal or other unexpected pressure variations or changes. After the predetermined time period, the vacuum may remain held and the dynamic portion of the dynamic pressure vessel (e.g. the pipette plunger or cylinder piston, etc.) is moved through a movement cycle within the pressure vessel. The pressure continues to be measured during this movement cycle and again may be evaluated for anomalies, unexpected pressure variations, or obvious leaks at the seal. Once the predetermined movement cycle is completed, the vacuum may be released. The method also involves applying a positive pressure within the dynamic pressure vessel via the manifold using a pressure source connected thereto. The positive pressure is held, via an isolation valve positioned along the pressure flow path, for a second predetermined time period (which may be the same or different from the vacuum holding time period). During this time period, pressure within the dynamic pressure vessel is measured to seek to identify any leaks in the seal or other unexpected pressure variations or changes. After this time period, the positive pressure remains applied and the dynamic portion of the dynamic pressure vessel is moved through a movement cycle within the pressure vessel (which may be the same or different from the movement cycle during the vacuum phase). The pressure continues to be measured during this movement cycle and again may be evaluated for anomalies, unexpected pressure variations, or obvious leaks at the seal. Once the movement cycle is completed, the pressure is released.

In various embodiments, the method may be used to test the pressure vessel under only the low-pressure/vacuum hold and cycle conditions. Or, the method may be used to test the pressure vessel under only the high-pressure hold and cycle conditions. In still another embodiment, both phases may be tested as discussed in the first aspect, above. Accordingly, when the method is discussed herein, it should be noted that the method may involve only one of the low pressure or high pressure phases without straying from the scope of this disclosure.

In another aspect, a computerized system for evaluating seal integrity is provided. The computerized system includes a dynamic pressure vessel attached to a testing apparatus via a manifold. This dynamic pressure vessel has a dynamic portion (e.g. the pipette plunger or cylinder piston, etc.) which has a seal thereon. The dynamic portion is movable within the dynamic pressure vessel. The computerized system is in communication with one or more pressure sensors operable to monitor pressure within the dynamic pressure vessel. A vacuum source is in communication with the manifold, and is electronically connected with the computerized system. A pressure source is in communication with the manifold, and is electronically connected with the computerized system. An actuator is engaged with a part of the dynamic portion which is operable to mechanically move the dynamic portion. This actuator is in electronic communication with the computerized system and can be activated by the computerized system. This computer controller is programmed and operable to carry out a seal integrity test. A vacuum may be drawn within the dynamic pressure vessel, against the seal, using a vacuum source connected to the manifold. The vacuum (or equivalent low pressure), is then held for a predetermined time period. During this time period, pressure within the dynamic pressure vessel is measured to seek to identify any leaks in the seal or other unexpected pressure variations or changes. After the predetermined time period, the vacuum may remain held and the dynamic portion of the dynamic pressure vessel (e.g. the pipette plunger or cylinder piston, etc.) is moved through a movement cycle within the pressure vessel. The pressure continues to be measured during this movement cycle and again may be evaluated for anomalies, unexpected pressure variations, or obvious leaks at the seal. Once the predetermined movement cycle is completed, the vacuum may be released. The method also involves applying a positive pressure within the dynamic pressure vessel via the manifold using a pressure source connected thereto. The positive pressure is held for a second predetermined time period (which may be the same or different from the vacuum holding time period). During this time period, pressure within the dynamic pressure vessel is measured to seek to identify any leaks in the seal or other unexpected pressure variations or changes. After this time period, the positive pressure remains applied and the dynamic portion of the dynamic pressure vessel is moved through a movement cycle within the pressure vessel (which may be the same or different from the movement cycle during the vacuum phase). The pressure continues to be measured during this movement cycle and again may be evaluated for anomalies, unexpected pressure variations, or obvious leaks at the seal. Once the movement cycle is completed, the pressure is released.

### BRIEF DESCRIPTION OF DRAWINGS

FIG. 1 provides a perspective detail view of an embodiment of the present disclosure.

FIG. 2 provides a perspective detail view of another embodiment of the present disclosure.

FIG. 3 provides a chart of an embodiment of a visual display shown by an embodiment of the present disclosure.

FIG. 4 provides a view of an embodiment of the present disclosure.

FIG. 5 provides a cross sectional view of a dynamic pressure vessel of the present disclosure.

FIG. 6 provides a side view of yet another embodiment of the present disclosure.

FIG. 7 provides a flow chart of operational steps of one embodiment of the present disclosure.

FIG. 8 provides a flow chart of operational steps of yet another embodiment of the present disclosure.

FIG. 9 provides a view of yet another embodiment of the system of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a method and system for performing a seal integrity test of a seal or seals within a dynamic pressure vessel. The term dynamic pressure vessel is used to refer to any structure having an adjustable internal volume, via, e.g. a plunger or piston. Common, non-limiting examples of dynamic pressure vessels contemplated herein include pipettes, automated pipettes, a pipette with a single plunger in communication with multiple dispensers, liquid handlers (such as air displacement systems or liquid displacement systems), syringes, combustion chambers (having pistons therein), and the like. The method involves drawing a vacuum within the dynamic pressure vessel, and measuring the pressure therein while held at low pressure. In many instances, a dynamic portion (plunger, piston, etc.) of the dynamic pressure vessel is held in a fixed position during this time. The method further involves moving the dynamic portion through a range of motion while drawing the vacuum on the dynamic pressure vessel. Again pressure is measured within the pressure vessel and can be analyzed for anomalies such as leaks, failure points, and the like. The method further involves applying a higher-than atmospheric pressure on the dynamic pressure vessel. The dynamic portion is held in place during a predetermined time period and the pressure within the dynamic pressure vessel is monitored. After the predetermined time period, while still applying pressure within the pressure vessel, the dynamic portion is moved through a movement range while still monitoring the pressure. The recorded pressure may be charted over time during the steps, and evaluated to determine seal integrity. The chart may be compared to an expected pressure chart, and/or prior tests of the same or similar seals or seal systems. Specific pressure ranges will be directly related to the maximum and minimum manufacturer specified operational ranges. In one embodiment, the static phases may be at or near the minimum (during vacuum phase) and maximum (during high pressure phase) of the manufacturer specified ranges. In another embodiment, the static phases may be at approximately 50%-80% of the manufacturer's specified ranges, allowing for additional pressure increases and decreases during the movement of the dynamic portion through the movement ranges. Specific pressure may vary depending on how great the movement range is.

As known in the art, a perfect vacuum cannot be achieved, and thus in the industry, various vacuum stages have been approximately established. Examples of industry terms include: Atmospheric pressure: 760 Torr; Rough vacuum: 760 to 25 Torr; Medium vacuum: 25 to 1×10−3 Torr; High vacuum: 1×10−3 to 1×10−9 Torr; Ultra-high vacuum: 1×10−9 to 1×10−12 torr; and Extremely high vacuum: Less than 1×10−12 Torr. The vacuums drawn in the presently contemplated systems are typically rough vacuum in the range of 350−25 torr, but of course this may vary depending on the type of dynamic pressure vessel being measured. Precise devices such as liquid handlers and pipettes have lower vacuums drawn compared to more robust systems (and corresponding seals) such as industrial scale hydraulic devices. In some cases, for microfluidics systems, vacuum ranges may go down to 0.1 mbar and below. Similarly, the high pressure phase may not be much higher than atmospheric with more precision devices receiving a lower pressure, compared to more robust industrial scale systems which may have a positive pressure phase of over 10,000 psi such as in large hydraulic piston systems.

The system contemplated herein is designed and capable of carrying out the method described in an efficient and effective manner. In some embodiments, the system may be controlled by an operator, turning various components on and off as well as moving the dynamic portion of the pressure vessel through the desired movement range. In other embodiments, a computer controller may be used to control one or more of the components of the testing system. For example, in most embodiments, the pressure sensors are electrically connected to a computer system (including a processor, memory, user interface and display) which can log the measured pressures and time recorded. The computer system may then present the logged data on, e.g. a chart or other display. During testing of computerized embodiments, in many cases the operation will include inputting information relating to the dynamic pressure vessel type, and a manifold type into the computerized controller via a user interface for data logging purposes.

In further embodiments, the vacuum and/or pressure pumps (which in some embodiments may be the same device) may be computer controlled by the same or different computer system as that measuring pressure. As such, the application and maintenance of pressures within the pressure vessel will be automatically applied for the appropriate time period. Valves and other operational components may also be in communication with the computerized system and controlled thereby. In some embodiments, a PID (Proportional Integral-Derivative) controller may be utilized by the computerized system to precisely manage operational components and elements. Further an actuator may be connected to or engaged with the dynamic portion (i.e. plunger, piston, testing head, etc.). The actuator is able to mechanically hold in place and/or move the dynamic portion through a predetermined movement range. This actuator may be controlled by the computerized system which may receive a hold command through a user interface or may receive parameters through the user interface instructing on the desired movement range, rate of movement, and the like. In further embodiments, the actuator may be programmed, via the computerized controller, to only apply a certain amount of force in a particular direction. This allows the actuator to mimic real-life application forces under realistic conditions. Too little force and the dynamic portion will not move through the required range, too much force will cause damage or overcome a seal's intended operational conditions, both of which may lead to faulty gathered data from the pressure sensors. The actuator also solve a problem common in the art that human operators may not always perform the range of motion portion of the testing method in the same way, at the same rate, through the same range, and by applying the same amount of force. This, the actuator may provide multiple advantages and solve potential issues from less-automated systems. The actuator may be any type of actuator capable of engaging with the dynamic portion.

In addition to pressure monitoring using pressure sensors, some embodiments may also monitor temperature within the dynamic pressure vessel, and in some cases at the dynamic portion of the pressure vessel. Temperature sensing allows for measurement of additional internal data and can also be indicative of operational changes and/or anomalous and undesirable conditions within the vessel during testing. For example, an unexpected temperature drop near the seal of the dynamic portion may indicate a leak. In another example, a temperature which is higher than an operating temperature of the seal, seal material, or lubricant, may indicate a potential risk for failure in the future. Temperature may also be used to identify abnormal heating within the system due to stress, strain, or other outside factors. These abnormalities may be used to verify that the device or system being tested is being used within the manufacturers specifications. In many embodiments, pressure and temperature measurement may be real time monitoring.

A primary advantage of the present disclosure is that the method and system measure seal integrity of the dynamic pressure vessel over time and under both static and varying pressure conditions. The testing may apply to any or all of the seals within the dynamic pressure vessel. Sometimes, there is only one seal (e.g. a sealing ring around a plunger or piston), other times, the pressure vessel has multiple seals. In either case, all seals may be evaluated. This multi-condition testing ability is important because it evaluates the seal(s) under realistic operational conditions, and in so doing, allows for the identification of seal breakdown or minor failure before the issue becomes a complete seal failure or other catastrophic condition preventing the pressure vessel from functioning as intended. Small leak detection or other anomalies (unexpected temperature or pressure changes and the like) may be advantageous because it allows for a pre-emptive replacement of seals before a full failure occurs. This will prevent equipment from being taken out of use after a failure has occurred, which is typically at an inopportune time, and/or after the failure which may lead to larger issues such as a destroyed batch of valuable product, damage to larger machinery components or other equipment, and the like.

In some cases, a manifold may be used which allows for testing multiple pressure vessels at one time. In such cases, in one embodiment a pressure sensor may be positioned on the manifold area to measure pressure of all the pressure vessels attached to the manifolds. In another embodiment, pressure sensors may be in communication with each of the pressure vessels to monitor the pressure within each. Further, valves may be positioned within or in communication with the manifold to allow for controlled isolation of each pressure vessel from the other pressure vessels.

As noted, both vacuum and high pressure is held within the dynamic pressure vessel under static conditions for a predetermined time period. These time periods may vary depending on the device being tested. Under some conditions, the vacuum holding time period may be the same as the high pressure holding time period. In other conditions, they may be different. Similarly, the movement cycles during vacuum and high pressure phase of the testing method may be the same, or may be different, depending on embodiment.

Turning back to operation of the computerized controller of the testing system (also referred to herein as the “computerized control system”) the process of recording the measured pressure during the predetermined time period may be achieved by storing the recorded data to a memory of a computerized control system. Similarly, the recording of the measured pressure during the first movement cycle may be recorded to the memory of the computerized control system, as is the measured pressure during the second predetermined time period and the measured pressure during the second movement cycle. This, all data may be stored on the computerized controller for later review, use in generation of charts, spreadsheets, databases, or other data display, and other uses. As noted, one application of the computerized controller is to generate a visual representation of the recorded pressure over time and presenting this on a display of the computer control system. The computerized controller may also be programmed to automatically identify anomalies, unexpected changes, and leaks based on this data by, e.g. comparing the chart to a second data set such as an expected chart and/or prior charts of the same or equivalent pressure vessels, and/or by comparing the raw data underlying the chart to a second data set such as expected raw data or prior raw data of the same or equivalent system. Prior data sets may be from a prior test of the dynamic pressure vessel, or a same type of dynamic pressure vessel, or an equivalent or similar dynamic pressure vessel. Identification of differences may be in the form of flagging on the display to draw a user's attention to the potential seal degradation or failure. In other embodiments, the computerized system may identify a trendline change of the test data compared to the second data set and may highlight or otherwise flag or visually identify the trendline change on the charted data of the current test.

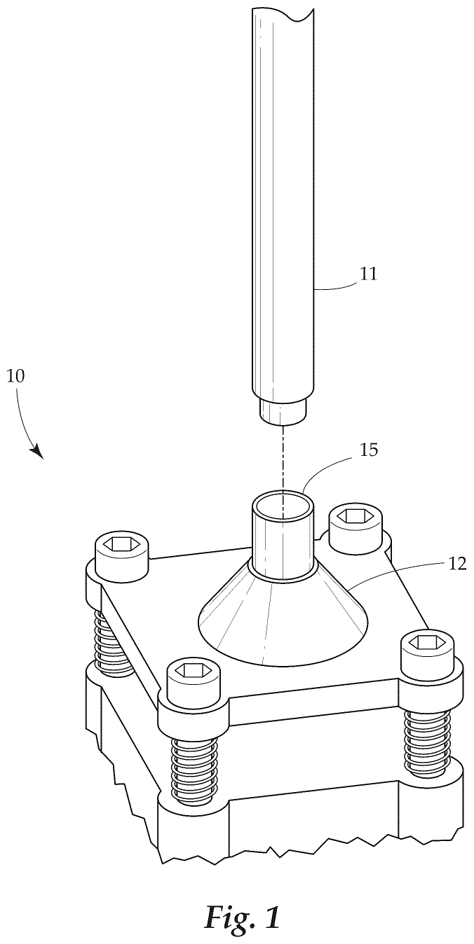

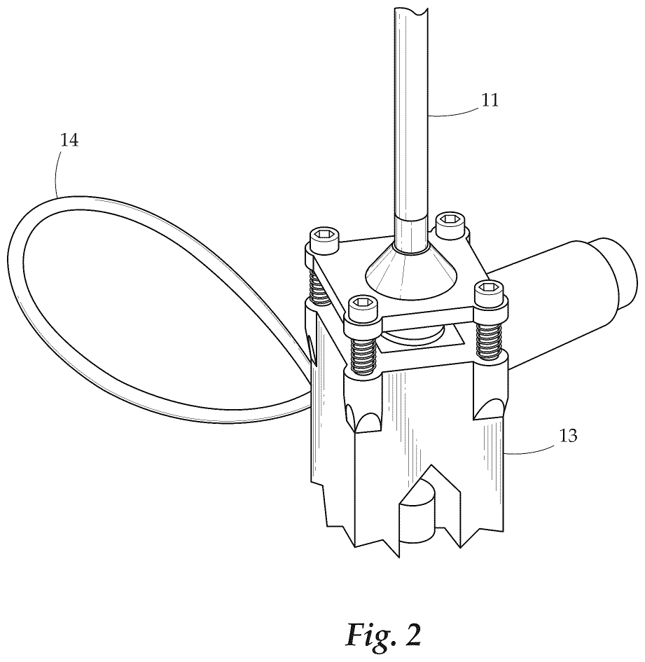

Turning now to FIG. 1, an embodiment of the present disclosure is shown. A portion of a system for testing seals within a dynamic pressure vessel is shown. Here, the dynamic pressure vessel 11 shown as a pipette having a tip removed. The dynamic pressure vessel 11 is connectable via a fitting 15 to a manifold 12 which is able to draw vacuum and apply pressure within the dynamic pressure vessel 11. FIG. 2 shows this portion at a wider view, showing a base 13 of the manifold which provides a housing for couplings and valve(s) to which tubes 14 connect for drawing a vacuum and/or applying pressure to the dynamic pressure vessel. Within the base 13 is a flow path or paths leading to manifold 12 and in turn dynamic pressure vessel via coupling 15.

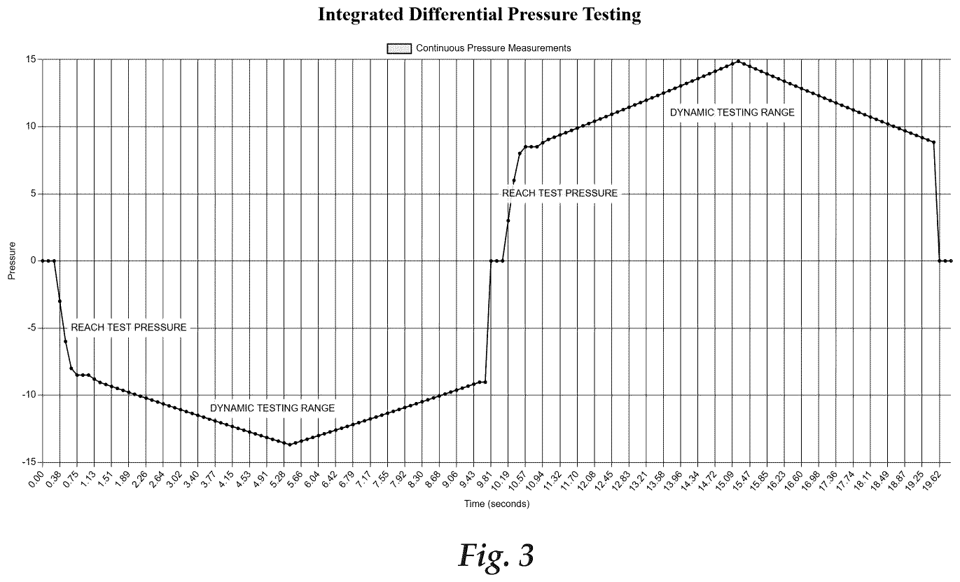

FIG. 3 shows an embodiment of a charted operation of the present pressure testing system. The chart shows a pressure within the dynamic pressure vessel vs time. A pressure sensor or sensors are positioned and operable to monitor pressure within the pressure vessel and are connected to a computerized system to record the sensed pressure data. In many embodiments, a chart such as that shown in FIG. 3 may be presented on a display for viewing by the computerized system. In this figure, atmospheric pressure is listed as “zero” and pressure numbers shown are kPa above or below atmospheric pressure. During phase #1, pressure is reduced from atmospheric pressure (shown on the chart as a base zero) progressively down to the vacuum phase at −16 kPa (kilopascals) from atmospheric pressure (of course, this may vary depending on embodiment. The vacuum is then held in the dynamic pressure vessel for a predetermined time period. In this embodiment approximately 13 seconds. Of course, this predetermined hold time period may be adjustable and may vary depending on device tested. Further the predetermined time period may be input into the computer controller for each test, or may be stored in a memory and pre-set. Next, the dynamic portion of the dynamic pressure vessel, in this embodiment the plunger of the pipette is moved through a predetermined movement range starting at phase #3. In this view, initially, the plunger is drawn up, further reducing the pressure, and then down, increasing the pressure (while still well below atmospheric). Pressure is recorded during this phase for later review and analysis. At phase #4, the vacuum is released and pressure within the dynamic pressure vessel returns to atmospheric pressure. Next, a similar process is repeated at phase 5 with high pressure instead of vacuum. The pressure is increased within the dynamic pressure vessel to approximately 19 kPa above atmospheric pressure and held at the high pressure for a predetermined time period. As is typical in real-world systems, it can be seen that the pressure initially over-shoots up to about 22 kPa, an then returns to the target lower. In this embodiment, the high pressure predetermined time period is 13 seconds, and again may vary depending on vessel being tested and testing goals. Next, the dynamic portion of the pressure vessel is moved while maintaining the high pressure and while the pressure sensor(s) record the pressure. Initially, the plunger is depressed, increasing the pressure, and then drawn out, lowering the pressure. In this embodiment, the dynamic portion is moved more than once as part of the pressure testing. It is noted that the dynamic portion movement range may be repeated during testing, in some embodiments. Naturally, in the high pressure phase, the plunger is urged outward to its maximum movement limit from pressure placed on it. As such, the movement range of the plunger, in such embodiment having a relatively freely movable dynamic portion, will be at one limit during the static portion. Therefore, depression of the plunger causes the pressure to increase, and releasing the plunger or otherwise bringing it to its other end of the movement range returns the pressure to approximately the static portion pressure. Finally, pressure is released and returned to atmospheric pressure, concluding the test method.

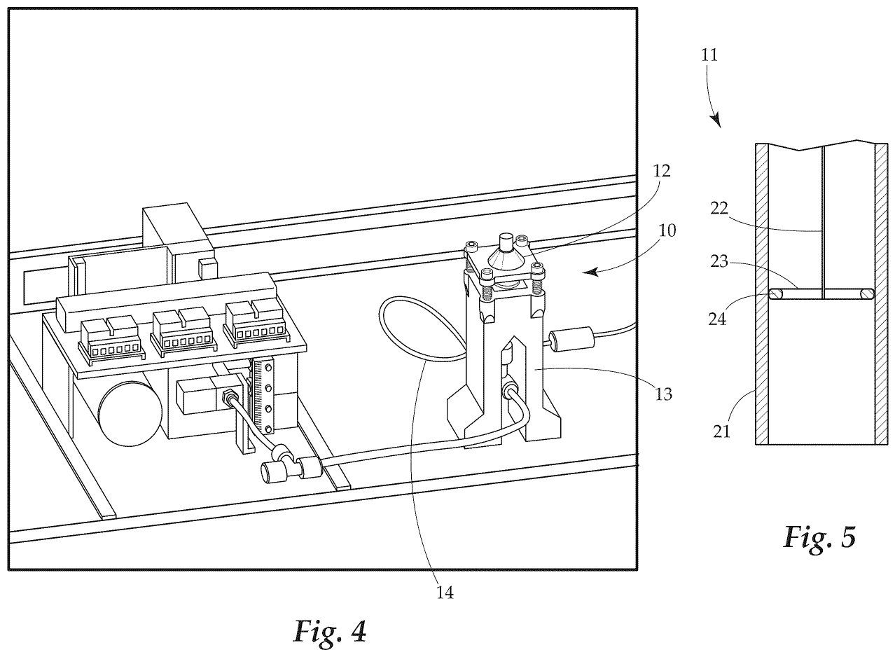

FIG. 4 provides a wider view of an embodiment of the system 10 for carrying out the pressure testing method. The manifold 12 connects to base 13 which provides the structure to receive different tubing for the high and low pressure phases (in other embodiments these may be the same tubing and same pump). Computerized control components 41 operate to control functioning of the system including vacuum and/or pressure pump actuation, valve actuation, pressure sensor monitoring and the like. Pressure sensor(s) may be positioned anywhere along a flow path of the pressure-applying system and vacuum drawing system. In many embodiments, the pressure sensor is positioned in or close to the manifold 12 or body 13 and the flow paths therein.

FIG. 5 shows a cross sectional view of an embodiment of the dynamic pressure vessel. Here, the dynamic pressure vessel 11 has a sidewall 21 which defines the interior space therein. Within this interior space is the dynamic portion, shown as a plunger 23, but may also be a piston, and the like as disclosed above. A sealing ring 24 is positioned around the perimeter of the plunger 23 and operates to provide a tight seal between the opposing sides of the plunger 23. An extending arm 22 extends from a rear of the plunger 23 and allows movement from outside of the dynamic pressure vessel.

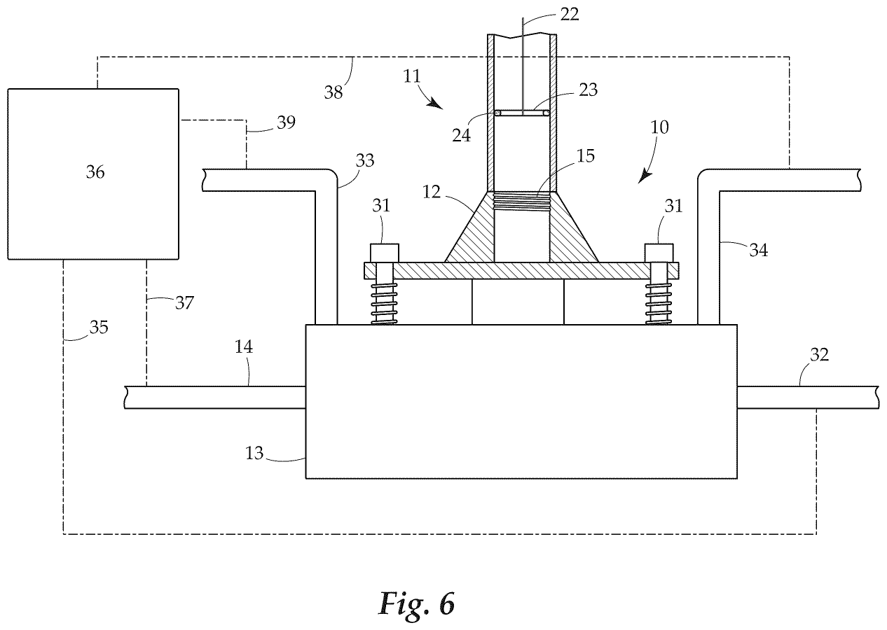

FIG. 6 provides a schematic view of another embodiment of the pressure testing system. In this view, the system is capable of both liquid and gas phase testing, i.e. applying gas and liquid at low and high pressures in the dynamic pressure vessel. As in other embodiments, the dynamic pressure vessel 11 is attached to the manifold 12 via a connector 15, shown in this view as a threaded connector. Manifold 12 connects to the base 13 via screws 31. Tubing connects into base 13 and can apply vacuum, draw a low pressure fluid, or apply high pressure liquid. Vacuum gas line 14 connects to a low pressure source such as a vacuum pump, high pressure gas line 33 connects to a pressure source such as a pressure pump. Low pressure liquid line 32 connects to a pump able to draw liquid away from the pressure vessel chamber, and high-pressure liquid line 34 connects to a pump able to apply liquid pressure to the pressure vessel chamber. These lines 14, 32, 33, 34, connect at the base 13 and are controlled and isolated by valves (not shown) and couplings (not shown). A computer controller 36 is in electronic communication (shown by dashed lines) with a plurality of pressure sensors 35, 37, 38, 39 which monitor pressure within the vacuum line 14 (pressure sensor 35) during its operation, high pressure gas line 33 (pressure sensor 39) during its operation, low pressure liquid line 32 (pressure sensor 35), and high pressure liquid line 34 (pressure sensor (38). In addition to these pressure sensors, additional sensors may optionally be placed within the base 13 or manifold 12, depending on configuration. While the embodiments above are disclosed as relating to gas phase methods, similar testing methods may be carried out using liquid instead. During the range of motion portion of the tests, the range may be very limited due to the non-compressibility of liquid, may be converted to a pressure application test rather than motion range, or may be carried out having the fluid in a flowable state (i.e. the dynamic portion may move, causing liquid to flow into or out of the pressure vessel chamber). Of course, as noted above, any of the above listed embodiments may also monitor temperature and other parameters without straying from the scope of this disclosure. Temperature and other sensors may be positioned anywhere along the testing system, and typically are positioned to measure temperature in or near the pressure vessel.

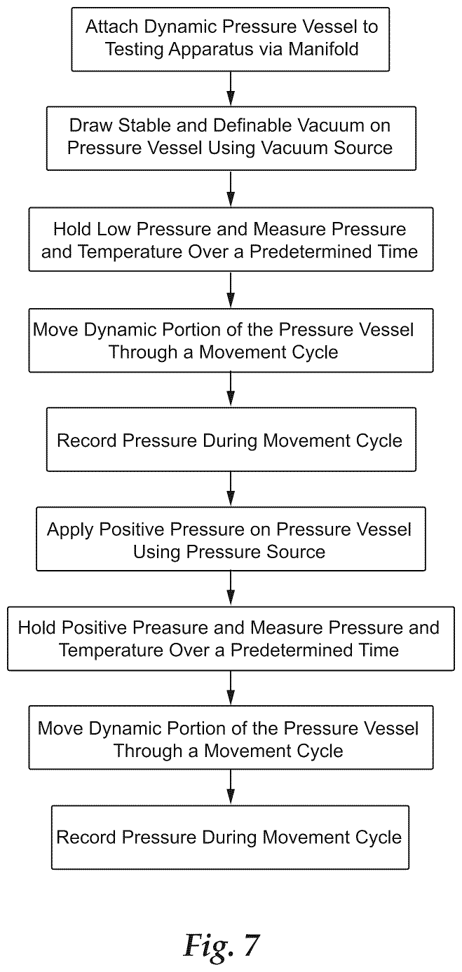

FIG. 7 provides a view of an embodiment of the testing method contemplated herein. Initially, a dynamic pressure vessel is attached to the testing apparatus via the manifold. Then, a stable and definable vacuum is drawn on the pressure vessel using a vacuum source such as a pump and the like. This low pressure is held, via an isolation valve in this embodiment, and the pressure and temperature in the pressure vessel is measured over a predetermined time period. While holding the low pressure, the dynamic portion of the pressure vessel is moved through a movement cycle while recording the pressure within the pressure vessel. Next, positive pressure is applied to the pressure vessel using a pressure source such as a pump, compressed gas source, and the like. This high pressure is held, via an isolation valve in this embodiment, and the pressure and temperature in the pressure vessel is measured over a predetermined time period. While holding the high pressure, the dynamic portion of the pressure vessel is moved through a movement cycle while recording the pressure within the pressure vessel. In one embodiment, the isolation valve may be the same valve for both the vacuum phase and high-pressure phase. In another embodiment, one isolation valve may be used for the vacuum phase, and another different one may be used for the high pressure phase.

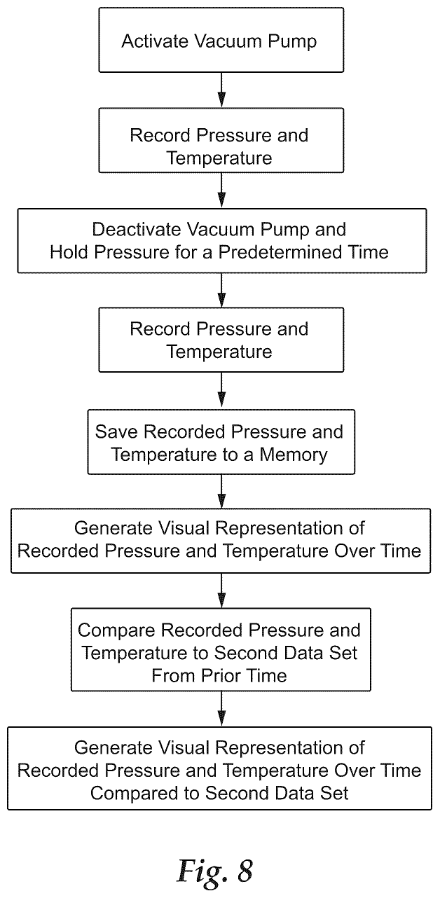

FIG. 8 provides a view of an embodiment of the operation of the system to carry out the testing method contemplated herein. A vacuum pump may be activated to draw a vacuum on the pressure vessel, recording pressure and temperature during this time. Then, once the desired low pressure has been reached, the vacuum pump may be deactivated and the low pressure in the vessel is held by an isolation valve specifically positioned and operable to hold the low pressure. Again this holding period is done while measuring pressure and temperature for a predetermined time. This measured data is recorded and saved to a memory of a computer. The process may then be repeated with the high-pressure phase as discussed above. The computer is then able to use this data to automatically generate a visual representation of the recorded pressure over time, and present this on a display of the computer. Further, the computer may be programmed to automatically compare the recorded data set to a second data set, which may be a sample data set of a known properly operating device, expected data ranges based on calculations, and/or a second data set from a prior time period of the same device, or equivalent device. This compared data may be presented on a visual representation comparing the two. In further embodiments, the computerized system may identify and flag differences between the two data sets for presenting on the visual display to alert operators to potential seal leaks, degradation, or failure. For example, a lower than expected pressure, higher than expected pressure, unexpected slow pressure drop over a time period, and the like. In another embodiment, the recorded data may also be used to track the linearity of the pressure along the length of the stroke. This may be important for some low-pressure applications as a smaller sub range of the stroke might be preferable to other ranges for fine work.

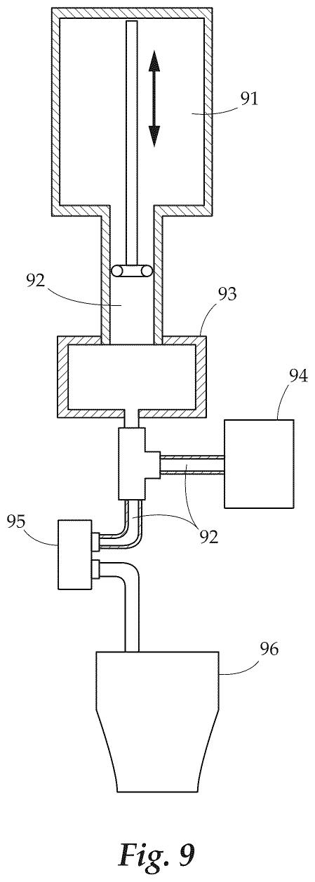

FIG. 9 provides a view of another embodiment of a system for carrying out the method contemplated herein. In this view, dynamic pressure vessel 91 is attached to an interface manifold 93. The pressure vessel has a movably cylinder/plunger which can adjust the volume within the pressure vessel. The connection creates an isolated pressure space 92 between the plunger and an isolation valve 95. Isolation valve 95 operates to open and close during the pressure adjustment phases (i.e. when drawing the vacuum/low pressure and when applying high pressure), and is closed during the holding periods of the two phases. Pressure and temperature sensors 94 are connected with the isolated pressure space 92 and in communication therewith allowing measurement of pressure and temperature (and any other conditions selected with additional sensors). On an opposite side of the isolation valve 95 is the pressure controller 96 which may be a vacuum pump or other device operable to draw a low pressure, and/or a pressure pump or other device operable to apply a higher-than-atmospheric pressure. The pressure controller 96 may be a single device operable to draw a vacuum and also apply high pressure, or may be two (or more) different devices, and is shown as a single unit solely for simplicity in this view. The isolation valve 95, pressure controller 96, sensors 94 and optionally the plunger may all be in communication with a computerized control systems (not shown) which operates to control these components to carry out the testing method, as discussed in detail above. Notably, similar components to those discussed above are provided with different numbering due to the different structural configurations in this view, but the same concepts and features are also applicable to embodiments discussed above.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is

1. A method of evaluating seal integrity comprising the steps of:
attaching a dynamic pressure vessel to a testing apparatus via a manifold, the dynamic pressure vessel having a seal;
drawing a vacuum within the dynamic pressure vessel using a vacuum source connected to the manifold;
holding the vacuum for a predetermined time period;
measuring a pressure within the dynamic pressure vessel during the predetermined time period;
after the predetermined time period, moving a dynamic portion of the dynamic pressure vessel through a first movement cycle, while still holding the vacuum within the dynamic pressure vessel;
measuring a pressure within the dynamic pressure vessel during the first movement cycle;
releasing the vacuum.

2. The method of claim 1 further comprising the steps of:
applying a positive pressure within the dynamic pressure vessel using a pressure source;
holding the positive pressure for a second predetermined time period;
measuring a pressure within the dynamic pressure vessel during the second predetermined time period;
after the second predetermined time period, moving the dynamic portion of the dynamic pressure vessel through a second movement cycle, while still holding the positive pressure within the dynamic pressure vessel;
measuring a pressure within the dynamic pressure vessel during the second movement cycle; and
releasing the positive pressure.

3. The method of claim 2 further comprising the step of recording the measured pressure during the predetermined time period to a memory of a computerized control system; recording the measured pressure during the first movement cycle to the memory of the computerized control system; recording the measured pressure during the second predetermined time period to the memory of the computerized control system; and recording the measured pressure during the second movement cycle to the memory of the computerized control system.

4. The method of claim 3 further comprising the step of generating a visual representation of recorded pressure over time and presenting the visual representation on a display in communication with the computerized control system.

5. The method of claim 4 further comprising comparing the recorded pressure to a second data set of recorded pressure.

6. The method of claim 2 wherein the manifold comprises a plurality of connection points, and comprising the step of connecting a plurality of dynamic pressure vessels to the manifold, wherein the vacuum source is able to draw a vacuum within the plurality of dynamic pressure vessels simultaneously, and wherein the pressure source is able to able to apply a pressure to the plurality of dynamic pressure vessels simultaneously.

7. The method of claim 1 wherein the dynamic pressure vessel is a cylinder having a piston.

8. The method of claim 1 wherein the dynamic pressure vessel is a pipette with a single plunger in communication with multiple dispensers.

9. The method of claim 1 wherein the dynamic portion of the dynamic pressure vessel is a plunger or a piston.

10. The method of claim 3 further comprising the step of detecting, based on an expected result saved on the memory of the computerized controller, an anomaly in the recorded pressure readings.

11. The method of claim 1 further comprising the step of measuring a temperature within the dynamic pressure vessel.

12. The method of claim 2 wherein the first movement cycle is the same as the second movement cycle.

13. The method of claim 1 wherein the step of holding the vacuum for a predetermined time period comprises holding the dynamic portion of the dynamic pressure vessel in a fixed position using an actuator engaged with the dynamic portion of the dynamic pressure vessel.

14. The method of claim 5 wherein the second data set is a prior test of the dynamic pressure vessel, and further comprising the step of identifying, using the computerized controller, a difference between the recorded pressure to the second data set, and flagging, on the display, a potential seal degradation or failure.

15. The method of claim 5 further comprising the step of identifying, using the computerized controller, a trendline between the recorded pressure to the second data set, and flagging, on the display, a potential seal degradation or failure.

16. The method of claim 3 further comprising the step of inputting information relating to the dynamic pressure vessel type, and a manifold type into the computerized controller via a user interface.

17. The method of claim 1 wherein the step of moving the dynamic portion of the dynamic pressure vessel through the first movement cycle is performed using a mechanical actuator.

18. The method of claim 1 wherein the step of holding the vacuum for the predetermined time period comprises the step of holding the dynamic portion of the dynamic pressure vessel in a fixed position using a mechanical actuator.

19. A computerized system for evaluating seal integrity comprising:
a dynamic pressure vessel attached to a testing apparatus via a manifold, wherein the dynamic pressure vessel comprising a seal attached to a dynamic portion;
a vacuum source in communication with the manifold;
a pressure source in communication with the manifold;
an actuator engaged with a part of the dynamic portion of the dynamic pressure vessel and operable to move the dynamic portion;
a computer controller programmed to carry out the steps of:
drawing a vacuum within the dynamic pressure vessel using the vacuum source;
holding the vacuum for a predetermined time period;
measuring a pressure within the dynamic pressure vessel during the predetermined time period;
after the predetermined time period, moving the dynamic portion of the dynamic pressure vessel through a first movement cycle, while still holding the vacuum within the dynamic pressure vessel;
measuring a pressure within the dynamic pressure vessel during the first movement cycle;
releasing the vacuum;
applying a positive pressure within the dynamic pressure vessel using the pressure source;
holding the positive pressure for a second predetermined time period;
measuring a pressure within the dynamic pressure vessel during the second predetermined time period;
after the second predetermined time period, moving the dynamic portion of the dynamic pressure vessel through a second movement cycle, while still holding the positive pressure within the dynamic pressure vessel;
measuring a pressure within the dynamic pressure vessel during the second movement cycle; and
releasing the positive pressure.

20. A method of evaluating seal integrity comprising the steps of:
attaching a dynamic pressure vessel to a testing apparatus via a manifold, the dynamic pressure vessel having a seal;
applying a positive pressure within the dynamic pressure vessel using a pressure source;
holding the positive pressure for a second predetermined time period;
measuring a pressure within the dynamic pressure vessel during the second predetermined time period;
after the second predetermined time period, moving the dynamic portion of the dynamic pressure vessel through a second movement cycle, while still holding the positive pressure within the dynamic pressure vessel;
measuring a pressure within the dynamic pressure vessel during the second movement cycle; and
releasing the positive pressure.
